(19) United States
(12) Patent Application Publication
(10) Pub. No.: US 2016/0062916 A1
(43) Pub. Date: Mar. 3, 2016

(54) CIRCUIT-BASED APPARATUSES AND METHODS WITH PROBABILISTIC CACHE EVICTION OR REPLACEMENT

(71) Applicant: The Board Trustees of the Leland Stanford Junior University, Palo Alto, CA (US)

(72) Inventors: Subhasis Das, Stanford, CA (US); Tor M. Aamodt, Vancouver (CA); William J. Dally, Los Altos Hill, CA (US)

(21) Appl. No.: 14/837,922

(22) Filed: Aug. 27, 2015

Related U.S. Application Data
(60) Provisional application No. 62/042,713, filed on Aug. 27, 2014.

(51) Int. Cl. G06F 12/12; G06F 12/08

(52) U.S. Cl. CPC G06F 12/128; G06F 12/0891; G06F 12/0897; G06F 2212/1021; G06F 2212/69

(57) ABSTRACT

Selection logic can be used to select between a set of cache lines that are candidates for eviction from a cache. For each cache line in the set of cache lines, a relative probability that the cache line will result in a hit can be calculated based upon: past reuse behavior for the cache line; and hit rates for reuse distances. Based upon the relative probabilities for the set of cache lines, a particular cache line can be selected from the set of cache lines for eviction.

### RELATED PATENT DOCUMENTS

This application relates to U.S. Provisional Patent Application Ser. No. 62/042,713 filed on Aug. 27, 2014, and entitled: SYSTEMS, APPARATUSES AND METHODS INVOLVING PROBABILISTIC CACHE REPLACEMENT, which, including the Appendices filed as part of the underlying provisional application, is fully incorporated by reference herein for all that it contains.

### FEDERALLY-SPONSORED RESEARCH AND DEVELOPMENT

This invention was made with Government support under contract H9823012C0303 awarded by the National Security Agency. The Government has certain rights in the invention.

### OVERVIEW

Computer memory systems can be organized as a hierarchy with different levels of memory located at different distances from the central processing unit (CPU). The levels of memory between the CPU and main memory are referred to as different cache levels. In some instances, the cache memory circuits can get progressively larger and slower as they get further from to the CPU. The last cache level before the main memory is sometimes referred to as a last level cache (LLC).

When access to a particular chunk of data is requested by the CPU, the different cache levels can be checked for the presence of the data. Each individually addressable chunk of data can be referred to as a cache line, or just a line. When the requested line is in a particular cache level, this is referred to as a hit. When the requested line is not present, it is referred to as a miss. When a miss occurs, data is retrieved (or written to) from a lower level in the memory hierarchy, which can result in additional delays as the lower level is accessed. In response to a miss, the accessed line can be placed into the cache level. This process may result in the removal, or eviction, of an existing cache line.

Aspects of the present disclosure address issues relating to the manner in which a cache line is selected for eviction, which can have a significant effect on the efficiency of the memory system. Moreover, particular aspects recognize that different levels of cache, such as LLC, may benefit from different eviction algorithms and approaches.

### SUMMARY

Various example embodiments are directed to a method for selecting between a set of cache lines that are candidates for eviction from a cache. The method includes calculating, for each cache line in the set of cache lines, a relative probability that the cache line will result in a hit based upon: past reuse behavior for the cache line; and hit rates for reuse distances. Based upon the relative probabilities for the set of cache lines, a particular cache line is selected from the set of cache lines for eviction.

Certain embodiments are directed toward a system for selecting between a set of cache lines that are candidates for eviction from a cache. The system can include logic circuitry that includes a probability calculator circuit configured to calculate, for each cache line in the set of cache lines, a relative probability that the cache line will result in a hit based upon past reuse behavior for the cache line, and hit rates for reuse distances. The logic circuitry can also include a selection circuit that is configured to select, based upon the relative probabilities for the set of cache lines, a particular cache line from the set of cache lines for eviction.

Embodiments of the present disclosure are directed to a method for selecting between a set of cache lines that are candidates for eviction from a cache. The method includes calculating, for each cache line in the set of cache lines, a relative probability that the cache line will result in a hit by: determining past reuse behavior for the cache line by summing elements from a reuse vector containing frequencies of reuse corresponding to different reuse distances for the cache line; and taking a dot product of the reuse vector with a hit rate vector containing hit rates for the different reuse distances. Based upon the relative probabilities for the set of cache lines, a particular cache line can be selected from the set of cache lines for eviction.

The above discussion/summary is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description in connection with the accompanying drawings, in which:

FIG. 1 depicts a system with logic for selecting between a set of cache lines that are candidates for eviction from a cache, consistent with embodiments of the present disclosure;

FIG. 2 depicts a block diagram for implementing cache replacement logic, consistent with embodiments of the present disclosure;

FIG. 3 depicts a block diagram for a probability calculator circuit, consistent with embodiments of the present disclosure;

FIG. 4 depicts a flow diagram for selecting between a set of cache lines that are candidates for eviction from a cache, consistent with embodiments of the present disclosure;

FIG. 5 depicts a block diagram for implementing cache replacement logic using a sample tag store, consistent with embodiments of the present disclosure; and

FIG. 6 depicts a block diagram for selecting between a set of pages that are candidates for eviction from memory, consistent with embodiments of the present disclosure.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems and methods involving cache line eviction or replacement policies. In certain implementations, aspects of the present disclosure have been shown to be beneficial when used in the context of cache line replacement that determines the probabilities that cache lines will receive a hit. In some embodiments, a hit probability can be determined for the cache lines based upon past reuse behavior for the cache line and hit rates for reuse distances. These and other aspects can be implemented to address challenges, including those discussed in the overview above. While not necessarily so limited, various aspects may be appreciated through a discussion of examples using such exemplary contexts.

Embodiments of the present disclosure are directed toward cache replacement policies that use an eviction algorithm based upon reuse frequencies in order to identify a cache line for replacement. The algorithm can generate scores for cache lines that are candidates for replacement and the scores can be used to select a particular cache line for replacement. As discussed herein, the algorithm can be configured to generate scores that represent a likelihood or probability that a cache line will be selected in the future. In particular, the algorithm can use reuse history data that indicates frequencies for different reuse distances for candidate cache lines. A (global) likelihood of selection for particular reuse times can then be used with the history data to determine the likelihood of selection (before replacement) for each cache line. For example, a likelihood (or probability) of selection for a particular cache line and a particular reuse distance can be determined from the frequency of use for the particular cache line and reuse distance when considered in combination with a corresponding global likelihood of a hit for the particular reuse distance. This can be repeated for each reuse distance at a desired granularity of reuse distance (e.g., for each reuse distance bin of a histogram). The likelihood for the line being selected at any of the possible reuse distances, can be then be determined from each of the individual likelihoods (e.g., by summation thereof).

As used herein, the term reuse distance refers to the number of accesses to the set containing a cache block, not necessarily unique, between consecutive accesses to that cache block. In other words, for a particular block of one or more cache lines, the reuse distance is set based upon how many accesses are made to the cache before the particular block is accessed again. The term cache line refers to a block of memory that corresponds to blocks of memory that are individually addressable from within the cache. In some instances and for ease of discussion, the term cache line is used to refer to the corresponding block of memory whether or not it is presently stored in the cache. For example, a data chunk corresponding to a cache line that gets evicted from the cache may still be referred to as a cache line after eviction occurs.

Consistent with embodiments, the cache replacement policies discussed herein can be particularly useful for last-level caches (LLCs), but the policies are not limited thereto. For example, misses at LLCs result in off-chip accesses that can consume significant energy and impact performance via higher latency and limited bandwidth. It is recognized that a least-recently-used (LRU) algorithm may perform poorly on LLCs. For example, if the lower level caches also use LRU, then references with short reuse distances will tend to be handled by the lower level caches. The remaining accesses, those reaching the LLC, will tend to include more moderate and long reuse distances than the lower level caches. As discussed in more detail herein, LRU algorithms can be less effective for selecting between references with longer reuse distances. Even scan-resistant replacement algorithms, such as dynamic reference interval prediction (DRRIP) can perform poorly on LLC reference streams. For example, DRRIP algorithms can be poor at discriminating between references with moderate reuse distances and those with long reuse distances.

Consistent with various embodiments, cache replacement selection can be carried out using a reuse distance distribution that includes reuse history for a plurality of different reuse distances, for example, as opposed to using just LRU stack distance. The granularity for the reuse distance distribution can be relatively coarse, which can reduce both the size of the distribution and the complexity of the cache replacement algorithm. Further, reuse history can be retained for blocks not currently in the cache. This can be particularly useful for allowing the cache replacement selection algorithm to discriminate between cache lines with long reuses histories, including cache lines with reuse histories longer than the size of the cache. Certain embodiments can thereby be useful for increasing the number of hits to blocks with long reuse history, relative to algorithms without such capabilities.

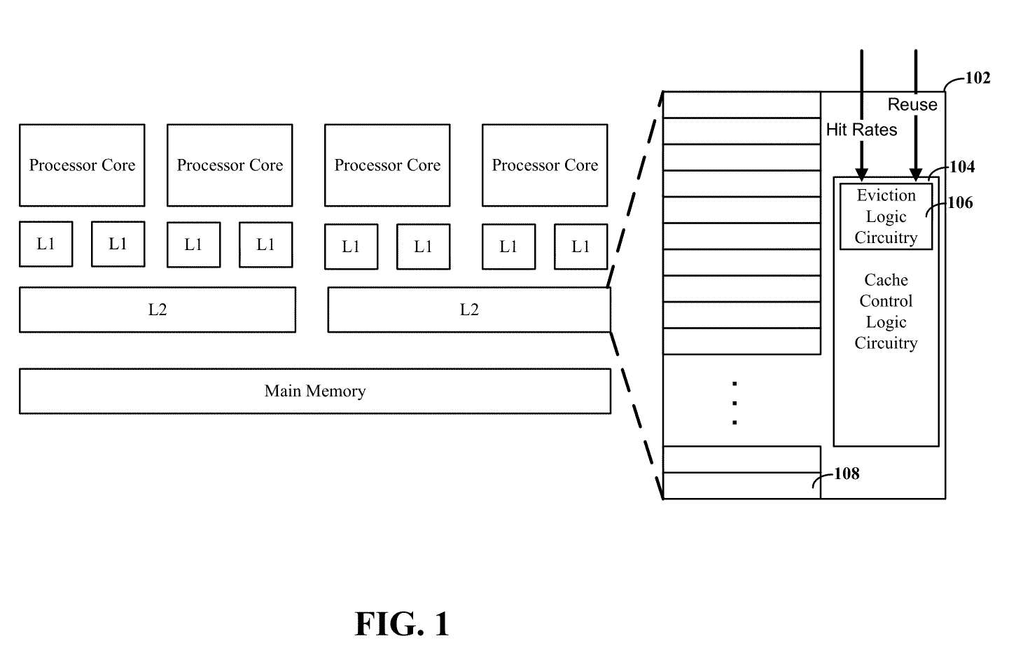

Turning now to the figures, FIG. 1 depicts a system with logic for selecting between a set of cache lines that are candidates for eviction from a cache, consistent with embodiments of the present disclosure. The system can include an integrated circuit (IC) chip with one or more (computer) processor cores and multiple levels of cache L1-L2. Although four cores and two levels of cache are shown, the various embodiments discussed can be implemented in connection with different numbers of cores and cache levels. In the system depicted in FIG. 1, the L2 cache level is shown as the LLC before leaving the IC chip to access main memory. Various embodiments are also directed toward different cache architectures. For example, the caches may reside on different IC chips and there may be a different number of caches or caches levels.

An example of a logical configuration for an L2 cache is shown by L2 cache 102. The cache control logic circuitry 104 is configured to control access to the cache lines 108. This can include determining cache hits and misses and controlling updates to the data contents of the cache.

Consistent with embodiments, the cache control logic circuitry 104 can include eviction logic circuitry that is configured select a victim cache line for eviction. The selection of the victim cache line can carried out using an algorithm that generates scores for a set candidate cache lines. The number of candidate cache lines can vary according to the specific type of cache being implemented. For example, the set of candidates can be of size M where the cache 102 is a W-way associative cache. According to various embodiments, the eviction logic circuitry 106 can be configured to calculate the scores using both a reuse history for the candidate cache lines and probabilistic hit rates for different reuse distances. The cache control logic circuitry 104 can then evict a cache line based upon a comparison between the scores of the candidate cache lines. In particular instances, a candidate cache line can be selected when it has a score representing the lowest probability of obtaining a hit in the future.

Consistent with certain embodiments, the replacement algorithm of the eviction logic circuitry 106 can use a coarse-grained reuse distance distribution that is designed to facilitate discrimination between reuse distances greater than the cache size by storing reuse history data about cache lines not stored in the cache. Storing the reuse history data about these cache lines allows the cache to maintain a portion of a working set with moderate reuse distance in cache by distinguishing from a working set with a long reuse distance. In some embodiments, the reuse history data can be stored as metadata in a memory circuit and the memory circuit located on the same integrated circuit (IC) chip as the cache. In some instances, the cache lines can be grouped together relative to the metadata, which can reduce overhead associated with the size of the memory circuit and associated access and control logic. For a particular, non-limiting, example metadata is stored at a page level of granularity for at least the cache lines that are no longer in the cache. Thus, each cache line within the same page can share the same reuse history metadata.

In certain instances, the data for the hit rates can be stored in the form of a cache distribution vector that indicates the probability that any cache line with a particular reuse distance would receive a hit under a particular cache replacement algorithm. In particular, the cache replacement algorithm can represent an optimal replacement algorithm for a predicted stream of memory accesses. Many cache replacement strategies, such as LRU, are based on an assumption that the hit rate is maximized by replacing the block with maximum expected time to reuse. While this principle holds for a simplified model of program behavior known as the independent reference model, it is recognized that this model can be a poor approximation of access streams, particularly at the LLC.

The independent reference model (IRM) can be used to describe program behavior which at each time the probability of accessing a block i is given by stationary probability L. An example optimal replacement algorithm, A₀, will evict the block j with maximum expected reuse distance 1/λⱼ. A cache line with reuse given by the independent reference model tends to have a geometric (i.e., exponential) reuse distance distribution. It is recognized that (surprisingly) the access sequence observed at the LLC for individual lines often does not follow this model. For example, experimental testing suggests that many cache lines in an LLC have reuse distance profiles that are multimodal.

It is recognized that evicting the line with maximum expected reuse distance can lead to poor replacement decisions when lines have multimodal reuse distributions. Consider a fully associative cache with capacity of 16 blocks and two replacement candidates A and B. Block A is predicted to be accessed 1024 references in the future with probability P=1. Block B, on the other hand, is predicted to be accessed either 8 references in the future with P=0:5 or 8192 references in the future with P=0:5. Block B has the higher expected reuse distance, 4100 vs 1024 for A. However it is better to replace Block A because it is almost certain to be evicted before it is reused 1024 references in the future. Block B on the other hand has a 50% chance of being hit after just 8 references. Embodiments of the present disclosure are directed toward an algorithm that uses reuse history data combined with cache distribution probability. As a result, Block A can be replaced instead of block B, despite Block B having the larger expected reuse distance.

To facilitate discussion of various embodiments, a reference stream can be defined to consist of accesses to lines (S₁; S₂; S₃; : : : ). For a single set of the cache, at time t, the current contents of the set can be defined by lines (x₁; x₂; x₃, : : : , x_{W}), where W is the associativity of the cache. An evicted line at time t is indicated by xₜ^{e}. A particular policy F can then be compared to an Optimal Replacement Policy (ORP), where ORP represents a replacement policy that is based upon prefect knowledge of the future reference stream. A difference between the miss rates of an ORP and policy F can happen for two reasons: (a) references that hit in the ORP policy but miss in the policy F, and (b) references that miss in the ORP policy but hit in the policy F. DF represents the number of references which miss in policy F but hit in the ORP. If a reference Sᵢ hits in an ORP but misses in F, then the presumption is that F evicted that line earlier. An indicator random variable lₓ_{ₑ}_{^{t}} can be defined as being equal to 1 if the evicted line xₜ^{e} receives a hit at time t′>t before being evicted under the ORP policy, and 0 otherwise. The outcome of this random variable depends upon the actual future reference sequence can be drawn from a probability distribution, which leads to:

$${Δ}_{F} = {\sum }_{t} {I}_{{x}_{t}^{e}}$$

Taking expectation of the expressions on both sides, and using the linearity of expectation, the result is:

$$E [ {Δ}_{F} ] = {\sum }_{t} {P}_{{x}_{t}^{e}} ( hit )$$

Where Pₓ_{ₜ}_{^{e}} (hit) is the probability that xₜ^{e} receives a hit before being evicted using ORP. Thus, DF can be minimized along with the miss rate, by replacing the line x that has the lowest Pₓ (hit), e.g., the lowest probability of hit under an ORP policy.

Accordingly, various embodiments are directed toward a cache controller that is configured to choose a victim line from a set by selecting the candidate L with a low (or the lowest) probability that the line L would receive a hit under an ORP (or “P_{L}^{hit}”) P_{L}^{hit} can be determined using reuse history data for line L and a probability distribution for different reuse distances. These distributions can be defined as: P_{L}(t) representing the probability that the next reuse distance for line L will be t, and, P^{hit}(t) representing the probability any line with reuse distance t would receive a hit under an ORP. Using these distributions, an estimate for hit probability can be obtained using the algorithmic formula:

$${P}_{L}^{hit} = \frac{{\sum }_{t > {T}_{L}} {P}_{L} ( t ) {P}^{hit} ( t )}{{\sum }_{t > {T}_{L} } {P}_{L} ( t )}$$

In this formula, T_{L} represents the reuse age of line L and the summations are taken for reuse distances greater than T_{L} since the next reuse distance will always be greater than the line's current age. P_{L}(t) is dependent on the particular line L, while P^{hit}(t) is independent of the line. Thus, a corresponding representation of P_{L}(t) can be stored for each line in the cache, but a single copy of P^{hit}(t) can be stored for use with any of the cache lines.

In connection with efforts for the present disclosure, it has been recognized that use of weightings from reuse distances without also considering the hit rates under an ORP (e.g., using a weighting of 1/t in place of P_{L}^{hit}) can lead to medium reuse distances replaced too readily. For instance, under a particular ORP the hit rates for reuse distances of 32-63 was around 85%; however, consideration of only reuse distances (e.g., using 1/t) might apply a weight these same accesses that corresponds to only about a 3% hit rate. As such, the use of reuse distances without hit rates can lead to eviction of cache lines with a relatively high probability of obtaining a hit.

According to embodiments, the cache selection algorithm can be based upon an assumption that the next reuse distance for a line is independent of the prior reuse distance for the same line. This allows for P_{L}(t) to be estimated by recording the frequency N_{L}(i) with which reuse distance i is observed for each line L. The distribution P_{L}(t) is then estimated using:

$${P}_{L} ( t ) = \frac{{N}_{L} ( t )}{{\sum }_{i} {N}_{L} ( i )}$$

If reuse distance t is binned into K bins, then for each line K counts, one for each bin, must be stored.

Embodiments are directed toward a selection algorithm that takes into account patterns in reuse distances by recording conditional frequencies. Given the previous reuse distance for L was T^{prev}, the next reuse distance can often be predicted with greater accuracy by recording and using the conditional frequency N_{L}(T^{prev}; i). The P_{L}(t) can thereby be estimated as:

$${P}_{L} ( t ) = \frac{{N}_{L} ( {T}^{prev} , t )}{{\sum }_{i} {N}_{L} ( {T}^{prev} , i )}$$

If reuse distance is binned into K bins, K2 different counts are stored, which can lead to higher overhead than if conditional frequencies are not used.

Various embodiments are directed toward estimating the cache distribution Pₕᵢₜ(t), using the average hit rate of ORP for each reuse distance t over a particular predicted usage pattern for the lines (e.g., as defined by the SPEC2006 suite).

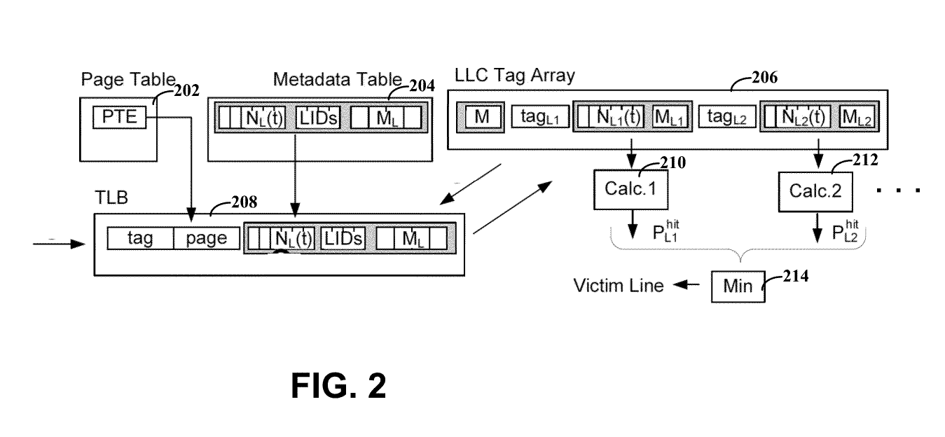

FIG. 2 depicts a block diagram for implementing cache replacement logic, consistent with embodiments of the present disclosure. The block diagram corresponds to logic for a single set of a 2-way LLC; however, the cache replacement logic can be configured to operate for a W-way LLC. On an LLC miss to line, the line is fetched from main memory (DRAM) and in parallel a victim is selected. To select a victim an array of hit probability calculator circuits 210, 212 each compute a value Pₕᵢₜ^{Li} for a respective candidate line Li using its age T_{Li} and reuse distribution N_{Li}(t). A selection circuit 214 (e.g., discrete/programmed logic) can be configured to select the candidate with the lowest probability of hit for eviction —to make space for the incoming line from main memory.

According to embodiments, the reuse distribution for the lines presently stored in the cache can be stored in a translation lookaside buffer (TLB) 208. As discussed herein, reuse history data for cache lines that are not presently stored in the cache can be maintained in a metadata table 204. In certain embodiments, the metadata can be stored at a page level of granularity. The reuse profile N_{L}(t) stored in the metadata table 204 can be loaded into the TLB 208 upon a miss for line L. The LLC tag array 206 can then be initialized using the reuse profile N_{L}(t) that was stored alongside the corresponding page in the TLB 208.

According to some embodiments, the profile block size can be different from the physical page size. For example, this distinction might be useful in the case of large pages (2 MB), where the behavior of all lines in the page might not be similar. The profile data will therefore not be a one-for-one match to the pages. To accommodate this potential mismatch, the metadata table can be maintained in a separate hardware structure relative to the TLB, along with the timestamps (ML), if they are used. Various embodiments are directed toward conserving memory space in the LLC. For example, a logarithmic spacing of reuse distances can be used to generate histogram bins. The logarithmic spacing can focus the histogram on the range where hit rate varies more with reuse distance. For example, reuse distances can be grouped into H histogram bins (e.g., H=6 can be sufficient). Bin 0 records reuse distances in the interval [1;W), where W is way size of the cache. Bin i=1; 2, : : : ; H−2 record reuse distances that fall in the interval [Wαⁱ⁻¹;W αⁱ) where a is a constant (e.g., α=2). The last bin (i=H−1) records reuse distances in the range [W α^{H-2}, ∞), that is, all reuse distances greater than α^{H-2} times the way size. In an experimental evaluation, a 4 MB, 16-way associative cache with 64 B lines was used. The corresponding intervals were [1,15], [16,31], . . . , [256, ∞). For the optimal policy, it was observed the hit rates for accesses with reuse distance ≧16 W was almost 0, while for reuse distance ≦W the hit rate was always 1. Experimental results and analysis suggest that smaller bin sizes offer little, if any, performance improvements in many instances.

Consistent with embodiments, the reuse distance profile of each line can be encoded. One reason for encoding can be to effectively use the available memory space. For instance, one encoding solution halves all of the counter values in the histogram bins when a bin value would otherwise exceed (overflow) the bin counter maximum. For example, suppose the counter precision is 4 bits (capable of representing decimal values 0-15) and the current counter values for the different reuse bins are [7, 9, 2, 10, 15, 8]. Once an access with reuse distance in interval 4 is observed, the counter value overflows leading to the halving of all the counter values. Thus the new counter values are [3, 4, 1, 5, 8, 4]. This method has the added benefit that it weights recent references more heavily than older references allowing the distribution to adapt more quickly to non-stationary behavior. Somewhat surprisingly, it has been discovered that even with only a 4 bit precision for all the counters, performance is not significantly degraded for many situations.

Consistent with embodiments, the current reuse distance for each line can be maintained and stored for use in determining a hit probability. To determine a reuse distance for each line the LLC can store a count M of accesses to each set of the LLC and a timestamp M_{L} for each line L. The age of a line, T_{L} is computed as T_{L}=M−M_{L}. When a line is reused, the LLC increments the histogram bin N_{L}(T_{L}) associated with the line's age and reset the corresponding timestamp to the current count M_{L}=M.

Various embodiments allow for encoding of the timestamps to save space. For instance, timestamps can be encoded in units of W=2, half the way size (i.e., for our 16-way cache we discard the low 3-bits of M when recording a timestamp M_{L}). Aliasing occurs if the reuse distance is greater than the range of the timestamp. However, the effect of this aliasing is small, in part because due to the geometric bin sizing aliased timestamps tend to fall in the >16 W bin. In a variety of instances, a 10-bit timestamp was found to be sufficient.

Embodiments of the present disclosure relate to a recognition that the frequency vectors of adjacent lines can often be similar. Accordingly, the storage overhead for reuse distance frequency vectors can be reduced by associating a single vector with a profile block of multiple consecutive lines. Although not limited to a specific size, the profile block can be set to match the page size (e.g., 64 consecutive lines or 4 KB). Somewhat surprisingly, larger profile blocks can sometimes provide better results, even without considering the reduced storage overhead.

Consistent with certain embodiments, data for reuse distance histograms are collected as an application runs. The data can be stored adjacent to the page translation in the TLB 208. Upon a TLB eviction the histogram data is stored in memory in a structure parallel to the page table 202. The parallel structure is identified as the metadata table 204. In particular embodiments, the metadata table can be located in the LLC. To avoid recursively fetching frequency vectors for the lines holding this data the lines can be assigned a uniform N_{L}(t). When a TLB access misses metadata can be loaded into the TLB alongside the page translation. After accessing the LLC and computing T_{L} the reuse histogram in the TLB can be updated along with the response to the original memory request.

Consistent with embodiments in which conditional reuse frequency is not used, the metadata for each page can contain a frequency vector N_{L}(t) for the page. In a particular example, this frequency vector can have of length 24 bits (6 bins times 4 bits per frequency). Also, a last access timestamp of 10 b length can to be stored for each line in the DRAM. For this example, the total DRAM storage overhead is 10 b+24/64 b or approximately 1.3 B per line. In addition to the metadata table, the timestamp and a frequency vector can be stored along with each line in the cache, resulting in an overhead of 10 b+24 b=34 b per line for the cache.

Consistent with embodiments in which conditional reuse frequency is used, the metadata for each page can contain a conditional frequency vector. As an example, the conditional frequency vector can have a length of 144 b (62 frequencies, each of 4-bit width). With 10 b last access timestamp and a 3 b last reuse bin for each line in the DRAM, the total overhead is 10 b+3 b+144/64 b, which is roughly 2 B per line in the DRAM. Embodiments of the present disclosure do not store the complete conditional frequency vector along with each LLC line because each line needs only the portion of the frequency vector corresponding to its last reuse distance. In this case the overhead per line is 10 b+24 b=34 b, at the expense of some additional traffic between the LLC and TLB to move the conditional frequency data therebetween as the last reuse distance changes.

Various embodiments are directed toward reducing the size of the metadata table through sampling of less than all of the lines in each block. To measure long reuse distance intervals for lines not currently in the LLC, the LLC can store the (10-bit) last access timestamps M_{L} for each line in the Metadata Table. To further reduce the overhead the LLC can be configured to sample selected (randomly selected or otherwise) subset of lines per page. For example, the subset can be determined by the first four accessed lines in each page. The LLC can use a set of line IDs (labeled LIDs in FIG. 2). Each LID can encode the offset of the line within the page. Thus, for 64 B lines and 4 KB page size the LIDs can each be 6-bits long. It has been discovered that sampling only four lines per page can still provide significant benefit. Consistent with embodiments using, for example, a 6-bit LID and a 10-bit timestamp per line, sampling 4 lines constitutes an overhead of 64 bits, thus bringing down the DRAM storage overhead to 1.4 bits per line.

Consistent with embodiments, the LLC can be configured to use a hit probability vector P^{hit}(t) to represent the likelihood that a reuse distance t will hit in the cache. As discussed herein, this probability vector is not dependent upon a particular line—the probability vector is the same for all lines. The LLC will not have perfect knowledge of the access stream in the future. Accordingly, probability vector can be set according to a likely access stream. For instance, a training set of access streams can be applied to a cache implementing the ORP and the average hit rates for each element (or bin) in the probability vector can be tracked and used to populate the hit probability vector. An example probability vector for 4 bits of granularity in the probability and for a 16-way, 4 MB cache is show in Table 1. Consistent with the values shown in Table 1 and corresponding embodiments, the values in the probability vector can be normalized by setting the highest probability bin (bin 0-15) value to the highest possible vector value (15) and the lowest probability bin (256-∞) value to the lowest possible value vector (1).

TABLE 1

| t bin | 0-15 | 16-31 | 32-63 | 64-127 | 128-255 | 256-∞ |
|---|---|---|---|---|---|---|
| 2⁴ · P^{hit} | 15 | 14 | 12 | 10 | 9 | 1 |

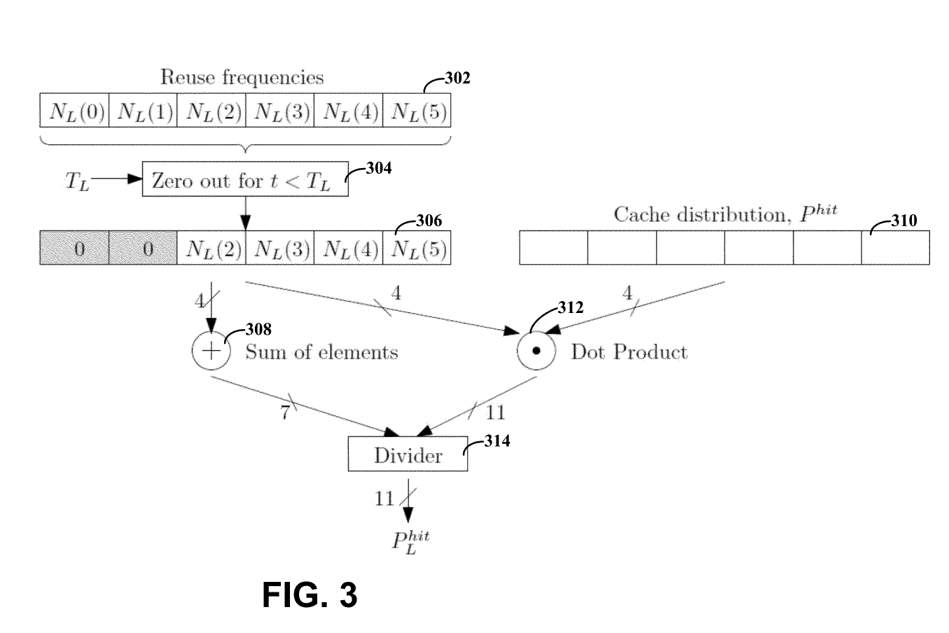

FIG. 3 depicts a block diagram for a probability calculator circuit, consistent with embodiments of the present disclosure. Vector 302 can be represented by N_{L}(t), where the value of N_{L}(t) is the frequency of accesses for different reuse distances t relative to a cache line L. As discussed herein, T_{L} represents the current reuse age of line L and prior reuse frequencies (t<T_{L}) can be ignored in the probability calculation by zeroing out the corresponding elements as shown by block 304. The resulting vector 306 can be summed by summing logic 308 and provided to dot product logic 312. The cache distribution, or hit probability vector, 310 can also be provided to dot product logic 312 which is configured to provide a sum of the products of the corresponding entries of the relevant inputs as the sequences of numbers (or in this context, the hit probability vector and the frequency vector). This is also characterized in Equation 1 below. Divider logic 314 can divide results of dot product logic 312 by the results of summing logic 308. Thus, an equation for the output of the probability calculator can be represented as:

$${P}_{L}^{hit} = \frac{{\sum }_{t > {T}_{L}} {N}_{L} ( t ) {P}^{hit} ( t )}{{\sum }_{t > {T}_{L}} {N}_{L} ( t )} \qquad Eq . 1$$

Consistent with embodiments, the arithmetic operations can be carried out using discrete logic components tailored toward the specific-recited functions. The relatively low precision of the operations can be useful for low energy consumption and small physical area use. For example, the various different types of logic (e.g., summer logic, divider logic and dot product logic) can be implemented using discrete hardware logic components in a manner that has a relatively low overhead in terms of energy consumption and physical area on an IC chip.

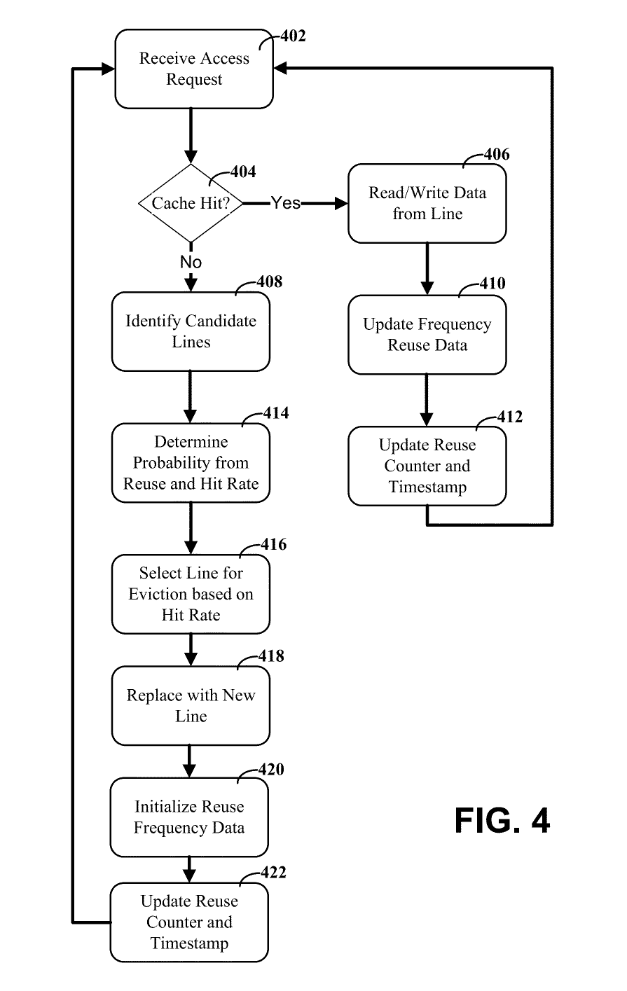

FIG. 4 depicts a flow diagram for selecting between a set of cache lines that are candidates for eviction from a cache, consistent with embodiments of the present disclosure. The flow diagram begins at block 402 with the receipt of an access request at the cache, which can be an LLC. As shown in block 404, the LLC can determine whether or not the access request results in a hit by checking the contents of the cache for a cache line that corresponds to the access request. If there is a hit, then the LLC contains the cache line and data corresponding to the access request and the LLC can process the access request by reading or writing to the cache line, per block 406. The particular manner of accessing the cache line can vary according to the configuration of the LCC (e.g., depending on whether or not the LLC is configured for write-through).

As discussed herein, the LLC can be configured to maintain and use reuse history data in selecting lines for eviction. Thus, the LLC can be configured to update reuse frequency counter data for the line L, as shown by block 410. For example, the reuse frequency counter data can be stored in an LLC tag array, such as the array 206 and 506 that is discussed in connection with FIGS. 2 and 4. The updating process can include incrementing the appropriate bin or element in a frequency reuse vector (or histogram) based upon the current reuse distance for the line L. Thus, if the current reuse distance (M−M_{L}) is 3 and there is a bin covering reuse distances 1-15, the value in this bin can be incremented. The LLC can also be configured to maintain data used to determine a reuse distance for the particular line L in an LLC tag array, such as the array 206. This can be done using a count M of a number of accesses to each set of the LLC and a timestamp M_{L} for the last access of each line in the cache. Accordingly, the LLC can be configured to increment the count M of accesses to the corresponding set and also to update a line-specific timestamp M_{L}, per block 412, respectively. The process can then repeat upon receipt of a new access request, per block 402.

If there is a cache miss, then the LLC can perform an update in the cache that includes insertion of a line corresponding to the access request and the eviction of an existing line. For a read request, the LLC can send the access request to main memory. When the data is returned from the main memory, it can be inserted into the LLC by replacing the evicted line. For a write request, the LLC can also send the access request to main memory. Depending on the type of cache, this can occur immediately (e.g., for a write through cache), or at a later time (e.g., for a write back cache). In either case, the LLC can be configured to select a line for eviction or before the access request process is completed, for accesses that include immediately accessing main memory, the selection can be performed in parallel with the access to memory.

The selection process can begin with the identification of candidate lines, per block 408. This can include, for example, identifying all lines in the same set as the line corresponding to the access request. For a W-way LLC, the number of candidate lines would be W. For each of the identified candidate lines, the LLC can then determine a relative probability that the cache line will result in a hit based upon past reuse behavior for the cache line and hit rates for reuse distances. As discussed herein, the past reuse behavior for the cache line can be in the form of a reuse history vector that is updated for each relevant access, and the hit rates for reuse distances can be global hit rates that are independent of a particular line. In certain embodiments, the determination can be carried out for each candidate line in parallel using W probability calculator circuits arranged in parallel. It is also possible to use less than W probability calculator circuits. For instance, a multiplexer circuit could be placed before a probability calculator circuit to allow for sharing between two or more candidate cache lines.

Using the calculated probabilities, a selection circuit of the LLC can select a line for eviction. In general, the cache line with the lowest probability can be selected; however, variations are also possible, such as using other criteria in addition to the determined probabilities. For example, probabilities that are relatively similar could be grouped together and another criteria could be used to select from the group with the lowest probability (e.g., randomly or LRU within the group). Accordingly, the absolute lowest probability might not always be selected for certain embodiments.

As shown in block 418, the LLC can then evict the selected line can and replace the evicted line with a new line, which corresponds to the access request from block 402. Consistent with various embodiments, the LLC can store reuse frequency data for cache lines that are not presently stored in the LLC. For instance, this can include storing the reuse data in a metadata table, such as the metadata table 204, which is discussed as having a page level of granularity (other block sizes and corresponding granularities are possible). Accordingly, the reuse data for the set can be used to initialize the tag array, per block 420. The reuse counter and timestamp for the new line can also be updated, per block 422.

It is recognized that the particular order of the flow diagram can be modified, that certain blocks may be optionally implemented, and that additional blocks can be added to the flow diagram depicted in FIG. 4. For instance, an additional analysis can be implemented to determine whether an access resulting in a miss should result in an eviction or if the eviction should be bypassed. As an example, the LLC could be configured to calculate the relative probability that the incoming/new cache line will result in a hit and only perform an eviction if the incoming cache line has a higher probability than the line to otherwise be evicted. Depending upon the particular application (e.g., as associativity increases), the use of a bypass determination can have only a marginal net effect on performance.

According to embodiments, a number of different variables can be considered in designing and using an LLC with a hit probability-based eviction algorithm. For example, the size of the profile block for the lines not current in cache (the metadata table 204) can be adjusted. Somewhat surprisingly, experimental results suggest that the performance of the LLC can increase as the size of the profile block increases. This is believed to be due to the larger profile blocks collecting reuse distances of more lines and thus getting trained faster.

Another possible variable is the precision of the frequency vector N_{L}(t). Experimental results suggest that even 1-bit reuse frequencies can improve performance. Further, the benefits of increased frequency vector precision appear to plateau around 4 bits.

A further variable is the training/values for the cache distribution (hit rate) vector P^{hit}(t). Experimental results were obtained by comparing a cache distribution vector trained using benchmark access streams to empirical distributions. For example, empirical probability distributions were generated by fixing the P^{hit} value for Bin 0 and Bin 5 at 15/16 and 1/16 respectively. The Phit value for Bin i, where 0<i<5 is set to be 15=16−Ki. Somewhat surprisingly, the empirical distributions were found to have similar performance to a trained cache distribution vector.

Yet another variable is the binning size for the frequency reuse vector. As discussed herein, a constant α can be used to control the size of the bins. Experimental testing for different values of α and corresponding number of total bins ranging from 1 to W (where W is the cache associativity) suggest that a values within the range of 1.5-2.5 produce fairly similar results. Values outside of that range, at least for the limited purposes of the experimental data, tended to suffer from degraded performance. For larger values of α, it is believed that there are two few bins to properly discriminate between the possible reuse distances. For lower values of α, it is believed that the distribution of reuses is spread between too many bins, resulting in increased noise.

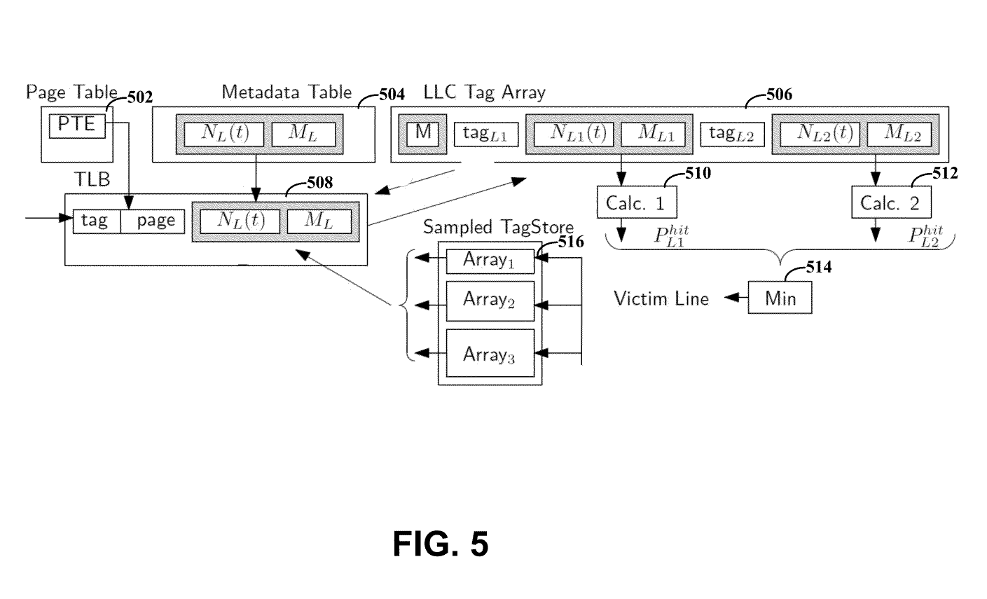

FIG. 5 depicts a block diagram for implementing cache replacement logic using a sample tag store, consistent with embodiments of the present disclosure. Similar to the discussion of FIG. 2, the block diagram of FIG. 5 corresponds to logic for a single set of a 2-way LLC; however, the cache replacement logic can be configured to operate for a W-way LLC. On an LLC miss to line, the line is fetched from main memory (DRAM) and in parallel a victim is selected. To select a victim line for replacement, an array of hit probability calculator circuits 510, 512 can each compute a value Pₕᵢₜ^{Li} for a respective candidate line Li using its age T_{Li} and reuse distribution N_{Li}(t). A selection circuit 514 can be configured to select (e.g., by comparison circuitry) the candidate with the lowest probability of hit for eviction—to make space for the incoming line from main memory.

According to embodiments, the reuse distribution for the lines presently stored in the cache can be stored in a translation lookaside buffer (TLB) 508. As discussed herein, reuse history data for cache lines that are not presently stored in the cache can be maintained in a metadata table 504. In certain embodiments, the metadata can be stored at a page level of granularity. The reuse profile N_{L}(t) stored in the metadata table 504 can be loaded into the TLB 508 upon a miss for line L. The LLC tag array 506 can then be initialized using the reuse profile N_{L}(t) that was stored alongside the corresponding page in the TLB 508.

Consistent with certain embodiments, data for reuse distance histograms are collected as an application runs. The data can be stored adjacent to the page translation in the TLB 508. Upon a TLB eviction, the histogram data can be stored in memory in a structure parallel to the page table 502. The parallel structure is identified as the metadata table 504.

Consistent with various embodiments, the cache replacement logic can include memory for storing data corresponding to sampled tag store 516. This sampled tag store data can help to reduce overall memory (DRAM) usage and associated data traffic by taking the place of the timestamps, such as those discussed in connection with FIG. 2. In the sampled tag store, a set of tag arrays can be maintained using an LRU replacement scheme. Each time a cache eviction occurs, the sampled tag store can be checked for a hit. The sampled tag store can include multiple differently sized arrays, and the current reuse distance can be determined based upon which of the arrays hit.

Consistent with some embodiments, the accesses used to maintain the tag arrays (which are used as a reuse history profile) are sampled at a frequency of 1/K. The bin sizes for the sampled tag store 516 are reduced by the same ratio of 1/K. The sampling can, in certain instances, be carried out using randomly or pseudo randomly selected accesses. The use of the sampled tag store 516 takes advantage of the recognition that given a cache size of C, an LRU replacement policy will only serve references having a reuse distance of <C and that the miss rates of caches do not change much if the cache size is reduced by the same ratio as the cache traffic. In other words, the miss rates will not change much if the cache size is reduced by a factor of K and a randomly selected 1/K fraction of the original cache traffic is served to the cache.

The array sizes can be set to desired bin sizes in order to realize the desired granularity in reuse distance. The contents of each tag array can be maintained according to an LRU replacement scheme. All accesses resulting in an eviction can be checked for a hit in the tag arrays. A hit indicates that the reuse distance is somewhere between the size of the next smallest tag array (or zero for the smallest tag array) and the size of the tag array with a hit. For example, consider the use of two tag arrays of size C and 2C, respectively. A hit in the smallest tag array carries an inference of a reuse distance that is less than C. A hit in the large tag array indicates a reuse distance between C and 2C, while a miss in both tag array indicates a reuse distance greater than 2C.

Extending the above example, additional arrays can be added to increase the number of bins. For instance, to have reuse bins for (0, C], (C, 2C], (2C, 4C], (4C, 8C], (8C, 16C], (16C, ∞], five tag arrays of sizes C, 2C, 4C, 8C, 16C could be used. While this can represent a relatively large amount of memory, the size of each tag array can be reduced by a factor of K. Experimental results suggest that, relative to storing timestamps as discussed in connection with FIG. 2, even for K=64 and a corresponding reduction of memory use of about one half, the performance is not significantly affected (e.g., only about a 0.6% reduction).

When using the sampled tagstore approach to update the TLB, a random sample of the cache accesses can be looked up in the sampled tag arrays. The reuse distance bin of a sampled accesses can be obtained as the minimum size of the tag array which causes a hit for that access. With the sampled tagstore technique, the timestamps need not be stored, and thus the overhead can be 24 b per page, or 0.4 b per line. Note that although small in size, the size of the metadata table is bigger than the free space in an x86-64 page table entry (PTE). Thus, rather than being incorporated into the PTE itself, the metadata can be stored in a separate table.

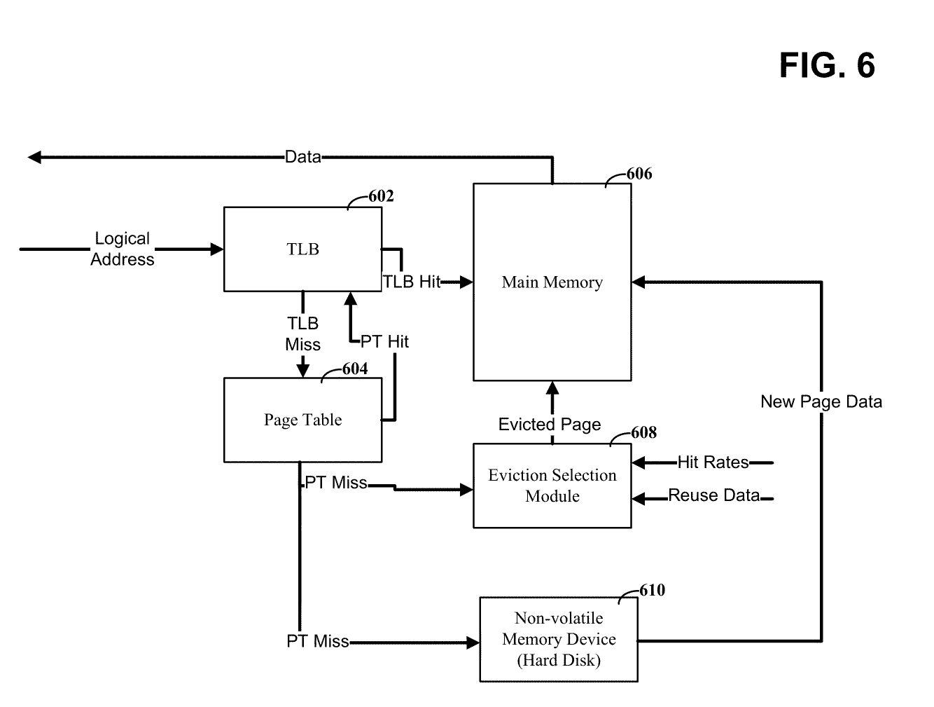

FIG. 6 depicts a block diagram for selecting between a set of pages that are candidates for eviction from memory, consistent with embodiments of the present disclosure. Consistent with various embodiments, it is recognized that an eviction selection algorithm using hit rates and reuse history data, as discussed herein, can be used for replacement of data other than in cache units located between a computer processor and main memory. For example, an eviction selection algorithm can be used to determine which page to replace upon a page table miss. With reference to FIG. 6, an operating system can generate a data access request that specifies a logical address. A TLB 602 can first be consulted. If the access results in a TLB hit, then the TLB 602 can provide the physical address necessary to access main memory 606. For ease of discussion no cache units are depicted; however, one or more cache levels can be included and available to provide access in place of main memory 606.

If the access requests results in a TLB miss, then a page table 104 can be consulted (e.g., a page walk) to determine whether or not the page corresponding to the access request presently resides in main memory 606. Although depicted as a separate block, page table 604 can reside in main memory 606 in certain implementations. If the page walk results in a hit, then the TLB 602 can be updated with the corresponding physical address and the requested data can be retrieved from main memory 606. If the page walk results in a miss, then the desired data can be retrieved from non-volatile memory device 610 (e.g., a hard disk drive). An eviction selection module 608 can then be used to select a page for eviction from main memory 606. The selection of the page can be carried out using an algorithm that generates scores for each page stored in main memory 606. According to various embodiments, the eviction selection module 608 can be configured to calculate the scores using both a reuse history for the pages and probabilistic hit rates for different reuse distances. The eviction selection module 608 can then evict a page based upon a comparison between the scores of the pages. In particular instances, an eviction selection module 608 can be selected when it has a score representing the lowest probability of obtaining a page table hit in the future.

Consistent with certain embodiments, the eviction selection module 608 can be implemented by configuring the operating system to perform the scoring and selection of candidate pages from the main memory. For example, the eviction selection module 608 can be initiated in response to a page table miss such that it runs during the relatively long access time required to retrieve the new page data from the non-volatile memory device 610. In various embodiments, portions of the eviction selection module 608 can be implemented using dedicated hardware logic.

It is recognized that in addition to the specific examples presented herein, various embodiments are directed toward the use of eviction selection algorithms discussed herein (and variations thereof) in contexts other than LLCs and page tables. For instance, the eviction selection algorithms discussed herein are contemplated as being useful in connection with various storage architectures where stored data is evicted and replaced upon determining that requested data is not present in an intermediate memory storage circuit.

Various blocks, modules or other circuits may be implemented to carry out one or more of the operations and activities described herein and/or shown in the appendices and appended figures. In these contexts, a “block” (also sometimes “circuit,” “logic,” or “module”) is a circuit that carries out one or more of these or related operations/activities. For example, in certain of the embodiments herein, one or more modules are discrete logic circuits or programmable logic circuits configured and arranged for implementing these operations/activities, as in circuit modules shown in the figures. It is recognized that the various circuits described herein, as sometimes distinguished using different adjectives, can be implemented using shared circuitry/logic and components, using separate circuitry/logic and components, or using a mix of shared and separate components. Such operations may be carried out, for example, in the CPU caching systems, controllers and in implementation of the probabilistic replacement policies and algorithms as described and shown in this disclosure.

Based upon the above discussion and illustrations, those skilled in the art will readily recognize that various modifications and changes may be made to the various embodiments without strictly following the exemplary embodiments and applications illustrated and described herein. In addition, the various embodiments described herein (including those in underlying provisional patent application and its appendices) may be combined in certain embodiments, and various aspects of individual embodiments may be implemented as separate embodiments. Such modifications do not depart from the true spirit and scope of various aspects of the invention, including aspects set forth in the provisional claims.

What is claimed is:

1. A system for selecting between a set of cache lines that are candidates for eviction from a cache, the system comprising:
logic circuitry that includes:
a probability calculator circuit configured to calculate, for each cache line in the set of cache lines, a relative probability that the cache line will result in a hit based upon:
past reuse behavior for the cache line; and
hit rates for reuse distances; and
a selection circuit that is configured to select, based upon the relative probabilities for the set of cache lines, a particular cache line from the set of cache lines for eviction.

2. The system of claim 1, wherein the logic circuitry includes a memory circuit storing a metadata table storing reuse history data vectors about cache lines.

3. The system of claim 2, wherein the logic circuitry includes a translation lookaside buffer configured to receive the reuse history data about cache lines from the memory circuit and to store the reuse history data vectors with address translation data.

4. The system of claim 2, wherein the logic circuitry includes:
a summing circuit configured to sum elements from the reuse history data vectors;
dot product logic configured to calculate dot product of the reuse history data vectors and a vector of the hit rates for the reuse distances; and
divider logic configured to divide an output of the dot product logic by an output of the summing circuit.

5. The system of claim 2, wherein the elements in reuse history data vectors about cache lines represent reuse distance histogram bins and wherein the histogram bins have increased reuse distance intervals for histogram bins with larger reuse distances.

6. The system of claim 1, wherein the cache is a last level cache in a multi-level cache.

7. A method for selecting between a set of cache lines that are candidates for eviction from a cache, the method comprising:
calculating, for each cache line in the set of cache lines, a relative probability that the cache line will result in a hit based upon:
past reuse behavior for the cache line; and
hit rates for reuse distances; and
selecting, based upon the relative probabilities for the set of cache lines, a particular cache line from the set of cache lines for eviction.

8. The method of claim 7, wherein the hit rates for reuse distances determined based upon reuse distances independent from a specific cache line the set of cache lines.

9. The method of claim 7, wherein the past reuse behavior for the cache line includes past hits to the cache line, and wherein the past hits are correlated with reuse distances.

10. The method of claim 7, wherein the calculating the relative probability includes correlating the past reuse behavior and the hit rates according to corresponding reuse distances.

11. The method of claim 7, wherein the hit rates for reuse distances are predetermined values based upon a training input set.

12. The method of claim 7, wherein the calculating the relative probability includes truncating elements in a vector of reuse frequencies for the cache line and summing the remaining elements in the vector.

13. The method of claim 12, wherein the calculating the relative probability further includes taking a dot product of the vector of reuse frequencies with a vector of hit rates for reuse distances.

14. The method of claim 13, wherein the calculating the relative probability further includes dividing a result of the dot product by a result of the summing to produce the relative probability.

15. The method of claim 7, further comprising determining past reuse behavior for cache lines by storing vectors that represent hits for cache lines, with the hits being correlated to reuse distances.

16. The method of claim 15, wherein the determining past reuse behavior includes associating each vector with a profile block of multiple cache lines.

17. A method for selecting between a set of cache lines that are candidates for eviction from a cache, the method comprising:
calculating, for each cache line in the set of cache lines, a relative probability that the cache line will result in a hit by:
determining past reuse behavior for the cache line by summing elements from a reuse vector containing frequencies of reuse corresponding to different reuse distances for the cache line; and
taking a dot product of the reuse vector with a hit rate vector containing hit rates for the different reuse distances;
selecting, based upon the relative probabilities for the set of cache lines, a particular cache line from the set of cache lines for eviction.

18. The method of claim 17, wherein the selecting a particular cache line from the set of cache lines for eviction includes selecting a cache line with a lowest determined probability from the set of cache lines.
